(19) United States
(12) Patent Application Publication
(10) Pub. No.: US 2018/0248425 A1
(43) Pub. Date: Aug. 30, 2018

(54) ROTOR OF AN ELECTRICAL ROTATING MACHINE WITH AN OPTIMISED CONFIGURATION OF PERMANENT MAGNETS

(71) Applicant: VALEO EQUIPEMENTS ELECTRIQUES MOTEUR, Creteil Cedex (FR)

(72) Inventors: Benoit WALME, Feucherolles (FR); Mamy RAKOTOVAO, Vitry Sur Seine (FR); Nam-Gook KIM, Saint-maurice (FR)

(21) Appl. No.: 15/557,397

(22) PCT Filed: Feb. 19, 2016
(86) PCT No.: PCT/FR2016/050379

§ 371 Date: Sep. 11, 2017

(30) Foreign Application Priority Data
Mar. 16, 2015 (FR) 1552136

(51) Int. Cl. H02K 1/27; H02K 1/28

(52) U.S. Cl. CPC H02K 1/276; H02K 1/28

(57) ABSTRACT

The invention mainly relates to a rotor (10) of an electrical rotating machine, comprising: a rotor body (11), particularly formed by a laminated core, and a set of permanent magnets (22), and wherein a ratio between the largest thickness (L3) of a permanent magnet (22) of the set of permanent magnets, (22) measured in a radial direction, and the largest width of the magnet (22) of the set of permanent magnets (22), measured in an orthoradial direction, is at least equal to 30%.

The invention relates to a rotor of an electrical rotating machine with an optimised configuration of permanent magnets.

In a commonly known way, the electrical rotating machine comprises a stator and a rotor integral with a shaft. The rotor can be integral with a driving and/or driven shaft and can belong to an electrical rotating machine in the form of an alternator, electric motor or reversible machine able to function in the two modes.

The stator is mounted in a casing configured to rotationally support the shaft for example via bearings. The stator comprises a body made from a laminated core of thin laminae forming a crown, the internal face of which is equipped with slots open towards the interior to receive phase windings. In a winding of the distributed wave type, windings are obtained for example from a continuous wire coated with enamel or from conductive elements in the form of pins held together by welding. Alternatively, in a winding of the “concentric” type, phase windings consist of closed coils which are wound around the teeth of the stator. Protection between the laminated core and the winding wire is assured either by a paper-type insulator, or by plastic moulding or by means of an insert. These windings are poly-phase windings joined by star or delta connections, the outputs of which are connected to an inverter.

In addition, the rotor comprises a body formed by a laminated core kept in the form of a pack by means of a suitable attachment system, such as rivets axially passing right through the rotor or with staples or even with buttons. The rotor comprises poles formed by permanent magnets accommodated in slots arranged in the rotor body.

Electrical rotating machines coupled with a turbo-compressor shaft are well-known (“electric supercharger” in English). This electric turbo-compressor at least partly enables the loss of power of the internal combustion engine with reduced cubic capacity, used on many motor vehicles in order to decrease their consumption and their emission of polluting particulates (principle known as “downsizing” in English), to be compensated. For this purpose, the electric turbo-compressor comprises a compressor turbine disposed on the air-intake conduit upstream or downstream from the internal combustion engine to enable the intake air to be compressed so that the cylinders of the internal combustion engine are filled to the maximum.

The electrical machine is activated to drive the turbine of the compressor in order to minimize the coupling response time, particularly during the transitional acceleration stages, or in the automatic restarting phase of the internal combustion engine after its deactivation (“stop and start” operation in English).

The object of the invention is to propose an electrical machine rotor, having improved magnetic performance by virtue of the configuration of its magnets, allowing the acceleration capacity of the electric turbo-compressor to be increased.

More precisely, the object of the present invention is a rotor of an electrical rotating machine particularly of an electrical machine able to rotate at a speed of about 60000 to 80000 rpm, comprising:
a rotor body, particularly formed by a laminated core, and
a set of permanent magnets,
   characterized in that a ratio between the largest thickness of a permanent magnet of the set of permanent magnets measured in a radial direction and the largest width of said magnet of the set of permanent magnets measured in an orthoradial direction is at least equal to 30%.

Such a permanent magnet allows the parasitic air-gap effects, due to production tolerances on the one hand of the rotor body and on the other hand of the magnets, to be compensated.

According to an embodiment, a ratio between the largest thickness of a permanent magnet of the set of permanent magnets measured in a radial direction and an external radius of said rotor body ranges between 15% and 30%, particularly between 18% and 28%.

Such a machine configuration is particularly suitable for operation at high rotational speeds, particularly by minimizing the inertia of the latter when its speed changes from 5000 to 70000 rpm in approximately 200 to 400 ms.

According to an embodiment, the rotor body has an external periphery having a cylindrical face substantially in the form of that of a cylinder.

Such a rotor enables the inductance (Lq) in the axis passing between the permanent magnets to be increased. This enables a reluctance torque which contributes to the production of engine torque at high-speed to be obtained. This is particularly suitable for electrical machines rotating at high-speed, namely at speeds of at least 60000 rpm.

According to an embodiment, an external diameter of said rotor ranges between 20 mm and 50 mm, particularly between 24 mm and 30 mm, for example between 20 mm and 35 mm.

This type of rotor is particularly suitable for high speeds, particularly about 60000 to 80000 rpm.

According to an embodiment, the rotor comprises four poles.

According to an embodiment, said external diameter of said rotor is about 26 mm.

According to an embodiment, each permanent magnet of the set of permanent magnets has a ratio between its largest thickness and an external radius of said rotor body ranging between 15% and 30%, particularly between 18% and 28%.

According to an embodiment, said thickness of said permanent magnet ranges between 2 and 4 mm, and is preferably 3 mm.

According to an embodiment, each permanent magnet of the set of permanent magnets has a thickness ranging between 2 mm and 4 mm, and is preferably equal to 3 mm.

According to an embodiment, the external radius of the rotor body ranges between 12 mm and 16 mm, particularly between 13 mm and 15 mm and is preferably about 14 mm.

According to an embodiment, the largest width of a permanent magnet of the set of permanent magnets ranges between 6 mm and 12 mm, particularly between 9 mm and 11 mm and is preferably 10 mm.

According to an embodiment, each permanent magnet of the set of permanent magnets has its largest width ranging between 6 mm and 12 mm, particularly between 9 mm and 11 mm and is preferably 10 mm.

According to an embodiment, each permanent magnet of the set of permanent magnets is substantially in the form of a rectangular parallelepiped.

According to an embodiment, each permanent magnet of the set of permanent magnets has chamfered angles.

According to an embodiment, the faces of said permanent magnet are flat.

According to an embodiment, at least one face of said permanent magnet is curved.

According to an embodiment, said curved face of said permanent magnet is located on the side of an external periphery of the rotor body.

Alternatively, said curved face of said permanent magnet is located on the side of an internal periphery of the rotor body.

According to an embodiment, said permanent magnets have radial magnetization.

According to an embodiment, an angular opening of each permanent magnet of the set is at least equal to 30°.

According to an embodiment, said rotor body comprises a plurality of slots each accommodating at least one permanent magnet of the set of permanent magnets.

According to an embodiment, each slot emerges on both sides of said rotor body.

According to an embodiment, said rotor comprises a single permanent magnet per slot.

Alternatively, said rotor comprises several permanent magnets per slot.

According to an embodiment, the permanent magnets of the set of permanent magnets are made of rare earth.

Alternatively, the permanent magnets of the set of permanent magnets are made of ferrite.

The object of the invention is also an electrical rotating machine comprising a coiled stator and a rotor as previously defined.

The winding of the stator can be a concentric winding.

According to an embodiment, said machine has a response time ranging between 100 ms and 600 ms, particularly between 200 ms and 400 ms, for example about 250 ms in order to change from 5000 to 70000 rpm.

According to an embodiment, the operating voltage is 12 V and the current in permanent mode is about 150 A.

According to an embodiment, preferably, the electrical machine is able to provide a current peak ranging between 150 A and 300 A, particularly between 180 A and 220 A.

According to an embodiment, an external diameter of the stator is lower than or equal to 100 mm, particularly lower than or equal to 80 mm, for example lower than or equal to 70 mm and is preferably about 50 mm.

According to an embodiment, preferably, an external diameter of the stator is substantially equal to 52 mm.

The invention will be better understood on reading the description below and on examining the figures which accompany it. These figures are only given on a purely illustrative, but by no means restrictive, basis of the invention.

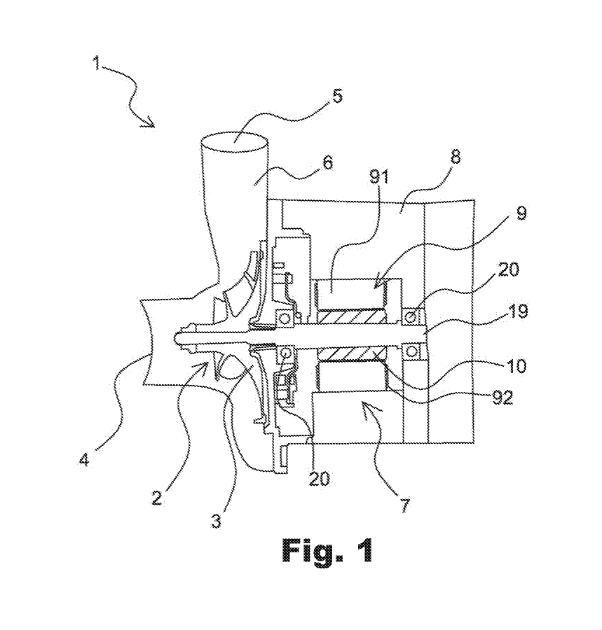

FIG. 1 is a sectional view of an electrical turbo-compressor comprising an electrical rotating machine according to the present invention;

FIG. 2 shows a perspective view of the rotor for the electrical rotating machine according to the present invention;

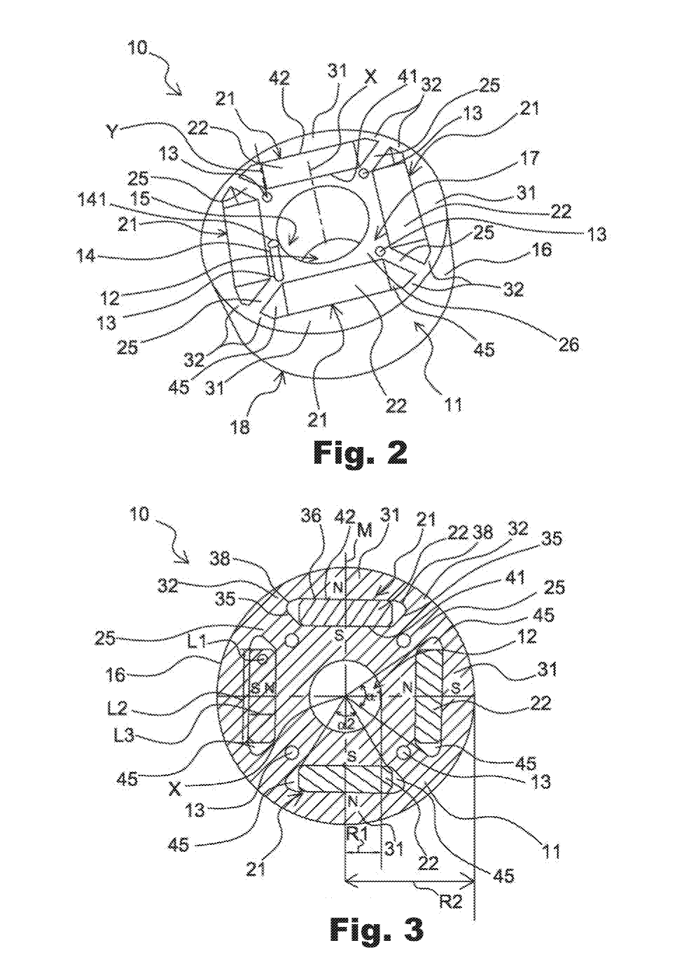

FIG. 3 is a cross-section view of the rotor for the electrical rotating machine according to the present invention;

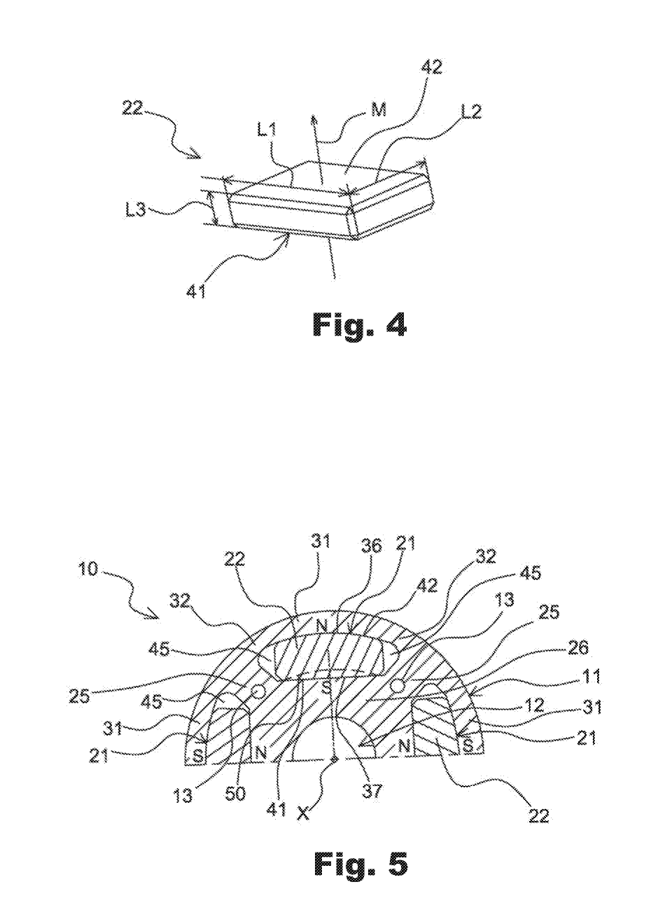

FIG. 4 is a perspective view of a permanent magnet intended to be inserted inside a slot of the rotor according to the present invention;

FIG. 5 shows a partial sectional view illustrating an alternative embodiment of the rotor for the electrical machine according to the present invention.

Identical, similar or analogous elements keep the same reference symbol from one figure to the next.

FIG. 1 shows an electrical turbo-compressor 1 comprising a turbine 2 provided with vanes 3 able to take in, via an inlet 4, uncompressed air resulting from a source of air (not illustrated) and to expel compressed air via outlet 5 after passing through a volute with the reference symbol 6. Outlet 5 could be connected to an intake manifold (not illustrated) located upstream or downstream from the internal combustion engine so that the cylinders of the internal combustion engine are filled to be maximum. In this case, the intake of air is performed in an axial direction, i.e. along the axis of turbine 2, and compression is performed in a radial direction perpendicular to the axis of turbine 2.

Alternatively, air intake is radial while compression is axial. Alternatively, air intake and compression are performed in the same direction relative to the axis of the turbine (axial or radial).

For this purpose, turbine 2 is driven by an electrical machine 7 mounted inside casing 8. This electrical machine 7 comprises a stator 9, which could be poly-phase, surrounding a rotor 10 with the presence of an air-gap. This stator 9 is mounted in casing 8 configured to rotationally support a shaft 19 via bearings 20. Shaft 19 is fixed in rotation with turbine 2 as well as with rotor 10. Stator 9 is preferably mounted in casing 8 by shrink-fitting.

In order to minimize the inertia of turbine 2 at the time of a request for acceleration by the driver, electrical machine 7 has a short response time ranging between 100 ms and 600 ms, particularly ranging between 200 ms and 400 ms, for example about 250 ms, in order to change from 5000 to 70000 rpm. Preferably, the operating voltage is 12 V and the current in permanent mode is about 150 A. Preferably, electrical machine 7 is able to provide a current peak, i.e. a current supplied over a continuous duration of less than 3 seconds, ranging between 150 A and 300 A, particularly between 180 A and 220 A. Alternatively, electrical machine 7 is able to function in alternator mode or is an electrical machine of the reversible type.

More precisely, stator 9 comprises a body 91 made from a laminated core of thin laminae forming a crown, the internal face of which is equipped with slots open towards the interior to receive phase windings of a winding 92. In a winding of the distributed wave type, windings are obtained for example from a continuous wire coated with enamel or from conductive elements in the form of pins joined together by welding. Alternatively, in a winding of the “concentric” type, phase windings consist of closed coils which are wound around the teeth of the stator. Protection between the laminated core and the winding wire is assured either by a paper-type insulator or by plastic moulding or by means of an insert. These windings are poly-phase windings joined by star or delta connections, the outputs of which are connected to an electronic control unit.

In addition, rotor 10 of rotational axis X shown in more detail on FIG. 2 has permanent magnets. Rotor 10 comprises a body 11 formed here by a laminated core extending in a radial plane perpendicular to axis X in order to reduce any eddy currents. This body 11 is made of ferromagnetic material. The laminae are retained by fixing means 14, for example rivets, axially passing right through the laminated core to form an easy-to-handle and transportable unit. Alternatively, the laminae are joined together by means of staples or buttons.

For this purpose, a plurality of fixing holes 13 are arranged in body 11 each allowing a fixing means 14 to pass through the laminae of body 11. In this case, each hole 13 has a circular shape. In addition, the fixing holes 13 are preferably through-holes, i.e. they axially emerge at each of axial ends 17, 18 of body 11, so that it is possible for rod 14 provided with a head 141 to pass through with one of its ends inside each hole 13 and the other end of which will be deformed for example by a snapping process in order to ensure axial retention of the laminated core. Alternatively, the rod 14 is not provided with head 141 and the two ends are then deformed by a snapping process. Alternatively, holes 13 can have a square, rectangular or any other shape suitable for the fixing means 14 to pass through. Alternatively, body 11 is made as a solid block.

Body 11 can be fixed in rotation to shaft 19 in various ways, for example by hafting the fluted shaft 19 with force inside central opening 12 of rotor 10, or using a key device.

Rotor body 11 has an internal periphery 15 defining central cylindrical opening 12 having an internal radius R1 for example of about 5 mm and an external periphery 16 defined by a cylindrical face of external radius R2 ranging between 10 mm and 25 mm, particularly between 12 mm and 15 mm and is preferably about 13 mm. Body 11 is also defined by two axial end-faces 17, 18 of annular form extending between internal periphery 15 and external periphery 16.

In addition, an external diameter of stator 9 is lower than or equal to 100 mm, particularly lower than or equal to 80 mm, for example lower than or equal to 70 mm and is preferably about 50 mm. Preferably, an external diameter of stator 9 is substantially equal to 52 mm.

Rotor 10 comprises a plurality of slots 21 in each of which a permanent magnet 22 is accommodated. Each slot 21 axially passes right through rotor body 11, i.e. from one axial end-face 17, 18 to the other. Two adjacent slots 21 are separated by an arm 25 emerging from a core 26 of rotor 10, so that an alternation of slots 21 and arms 25 exists whenever a circumference of rotor 10 is followed. Body 11 also comprises polar walls 31 each located between two adjacent arms 25. Each polar wall 31 extends between an inner face 36 in contact with a permanent magnet 22 and external periphery 16 of rotor 10. Moreover, each arm 25 is connected to a corresponding polar wall 31 via a bridge 32.

Thus, as FIG. 3 shows, slots 21 are each defined by two faces 35 of two adjacent arms 25 facing one another, an inner flat face 36 of a polar wall 31 extending in an orthoradial direction, a flat face 37 arranged in core 26 parallel with face 36, and inner faces 38 of two bridges 32. The junctions between faces 35 and 38 could be rounded in order to facilitate manufacturing of the laminated core.

As quite visible on FIGS. 3 and 4, magnets 22 have a L1 length measured along axis X of rotor 10 (the L1 length is perpendicular to the plane of the lamina on FIG. 3), a L2 width measured in an orthoradial direction, as well as a L3 thickness measured in a radial direction.

A ratio between the largest thickness L3 of each magnet 22 and the largest width L2 of magnet 22 is at least equal to 30%.

Moreover, a ratio between the largest thickness L3 of each magnet 22 measured in a radial direction and an external radius of the rotor body 11 range between 15% and 30%, particularly between 18% and 28%.

It should be noted that the largest dimension L1-L3 of an element is understood to mean the largest dimension measured in the given direction (axial, radial or orthoradial direction) corresponding to the largest dimension of the largest section of the element in the given direction.

The L3 thickness of each magnet 22 ranges between 2 and 4 mm, and is preferably 3 mm. In addition, the largest width L2 of a permanent magnet 22 of the set ranges between 6 mm and 12 mm, particularly between 9 mm and 11 mm and is preferably 10 mm.

Alternatively, the various ratios as well as the various dimensions mentioned above are only verified for certain magnets 22 of the set. In all cases, at least one magnet 22 of the set verifies the ratios and has the dimensions cited above.

As visible on FIG. 4, permanent magnets 22 have a rectangular parallelepiped form, the angles of which are slightly chamfered. Magnets 22 have radial magnetization, i.e. the two faces 41, 42 parallel in relation to each other having an orthoradial orientation are magnetized so as to be able to generate a magnetic flux in a radial direction M relative to axis X. Among these parallel faces 41, 42, inner face 41 located on the side of axis X of rotor 10 and outer face 42 located on the side of external periphery 16 of rotor 10 are evident.

As quite visible on FIGS. 3 and 5 where letters N and S correspond to the north and south poles respectively, magnets 22 located in two consecutive slots 21 have alternate polarities. Thus, from one slot 21 to the other; inner faces 41 of magnets 22 supported against flat face 37 arranged in core 26 have alternate polarity and outer faces 42 of magnets 22 in contact with inner face 36 of the corresponding polar wall 31 have alternate polarity.

Inner 41 and outer 42 faces of each magnet 22 are level in this case, just as the other faces of each magnet 22. Alternatively, as illustrated on FIG. 5, outer face 42 of each magnet 22 is curved, while inner face 41 of magnet 22 is flat, or vice versa. Inner face 36 of polar wall 31 then has a corresponding curved form. Hence the retention of magnet 22 inside a slot 21 is improved. Alternatively, the two side faces 41 and 42 are curved in the same direction (see dotted line 50), so that each magnet 22 generally has a tile shape.

In addition, magnets 22 do not fill slots 21 completely, so that there are two empty spaces 45 on both sides of magnet 22. The volume of air defined by all spaces 45 of rotor 10 enables the inertia of rotor 10 to be reduced.

For this purpose, angular opening al of a slot 21 is higher than the angular opening a2 of a corresponding permanent magnet 22. The angular opening α1, α2 of a given element (slot 21 or magnet 22) is defined by the angle formed by two planes each passing through axis X and through one of the ends of said element. In an exemplary embodiment, angular opening α1 of each slot 21 is strictly higher than 40°, while the angular opening α2 of a magnet 22 is at least 30°. In a particular exemplary embodiment, angular opening α1 of each slot 21 is about 73°, while the angular opening α2 of a magnet 22 is about 67°.

Magnets 22 are preferably made of rare earth in order to maximize the magnetic power of machine 7. Alternatively however, they could be made of ferrite according to application and the required power of electrical machine 7. Alternatively, magnets 22 can be made of different materials to reduce the costs. For example, a rare earth magnet and a less powerful but less expensive ferrite magnet can be used alternately in slots 21. Certain slots 21 could also be left empty according to the required power of electrical machine 7.

For example, two diametrically opposite slots 21 can be empty. The number of slots 21 here is equal to four, just as the number of associated magnets 22. It is however possible to increase the number of slots 21 and magnets 22 according to application.

In addition, a single permanent magnet 22 is inserted inside each slot 21. Alternatively, several magnets 22 stacked over one another inside the same slot 21 could be used. For example two permanent magnets 22 stacked axially or orthoradially over one another which, as the case may be, can be made from different materials, could be used.

Rotor 10 could also comprise, inside each slot 21, a spring-type mounting element for the magnets or pin made from a magnetic material which is more flexible than magnets 22. These elements permit easier insertion of magnets 22 in slots 21 which is performed by making magnets 22 slide parallel with axis X of rotor 10 and guarantee the mechanical mounting of the magnets. Alternatively, the magnets can be held in the slot by an adhesive.

Rotor body 11 can also comprise two retention plates (not illustrated) arranged on both sides of rotor 10 on its axial end-faces. These retention plates ensure magnets 22 are axially held inside slots 21 and also serve to balance the rotor. The flanges are made of non-magnetic material, for example aluminium.

Of course, the above description was only given by way of example and does not restrict the scope of the invention from which there would be no departure if the various elements were replaced by any other equivalents.

1. Rotor (10) of an electrical rotating machine, particularly of an electrical machine, able to rotate at a speed of about 60000 to 80000 rpm, comprising:
a rotor body (11), particularly formed by a laminated core, and
a set of permanent magnets (22),
wherein a ratio between the largest thickness (L3) of a permanent magnet (22) of the set of permanent magnets (22) measured in a radial direction and the largest width of said magnet (22) of the set of permanent magnets (22) measured in an orthoradial direction is at least equal to 30%.

2. Rotor according to claim 1, wherein a ratio between the largest thickness (L3) of a permanent magnet (22) of the set of permanent magnets (22) measured in a radial direction and an external radius (R2) of said rotor body (11) ranges between 15% and 30%, particularly between 18% and 28%.

3. Rotor according to the claim 1, wherein the rotor body (11) has an external periphery having a cylindrical face substantially in the form of that of a cylinder.

4. Rotor according to claim 1, wherein an external radius (R2) of the rotor body (11) ranges between 12 mm and 16 mm, particularly between 13 mm and 15 mm and is preferably about 14 mm.

5. Rotor according to claim 1, wherein the largest width (L2) of a permanent magnet (22) of the set of permanent magnets (22) ranges between 6 mm and 12 mm, particularly between 9 mm and 11 mm and is preferably 10 mm and in that wherein the thickness (L3) of said permanent magnet (22) ranges between 2 mm and 4 mm and is preferably 3 mm.

6. Rotor according to claim 1, wherein each permanent magnet (22) of the set is substantially in the form of a rectangular parallelepiped.

7. Rotor according to claim 1, wherein at least one face (42) of said permanent magnet (22) is curved.

8. Rotor according to claim 7, wherein said curved face (42) of said permanent magnet (22) is located on the side of an external periphery (16) of the rotor body (11).

9. Rotor according to claim 1, wherein said permanent magnets (22) have radial magnetization.

10. Rotor according to claim 1, wherein an angular opening (a2) of each permanent magnet (22) of the set is at least equal to 30°.

11. Rotor according to claim 1, wherein said rotor body (11) comprises a plurality of slots (21) each accommodating at least one permanent magnet (22) of the set of permanent magnets (22).

12. Rotor according to claim 11, wherein each slot (21) emerges on both sides of said rotor body (11).

13. Rotor according to claim 1, wherein the permanent magnets (22) of the set of permanent magnets (22) are made of rare earth.

14. Electrical rotating machine comprising a coiled stator and a rotor (10) as defined according to claim 1.

15. Rotor according to the claim 2, wherein the rotor body (11) has an external periphery having a cylindrical face substantially in the form of that of a cylinder.

16. Rotor according to claim 2, wherein an external radius (R2) of the rotor body (11) ranges between 12 mm and 16 mm, particularly between 13 mm and 15 mm and is preferably about 14 mm.

17. Rotor according to claim 3, wherein an external radius (R2) of the rotor body (11) ranges between 12 mm and 16 mm, particularly between 13 mm and 15 mm and is preferably about 14 mm.

18. Rotor according to claim 2, wherein the largest width (L2) of a permanent magnet (22) of the set of permanent magnets (22) ranges between 6 mm and 12 mm, particularly between 9 mm and 11 mm and is preferably 10 mm and wherein the thickness (L3) of said permanent magnet (22) ranges between 2 mm and 4 mm and is preferably 3 mm.

19. Rotor according to claim 3, wherein the largest width (L2) of a permanent magnet (22) of the set of permanent magnets (22) ranges between 6 mm and 12 mm, particularly between 9 mm and 11 mm and is preferably 10 mm and wherein the thickness (L3) of said permanent magnet (22) ranges between 2 mm and 4 mm and is preferably 3 mm.

20. Rotor according to claim 4, wherein the largest width (L2) of a permanent magnet (22) of the set of permanent magnets (22) ranges between 6 mm and 12 mm, particularly between 9 mm and 11 mm and is preferably 10 mm and wherein the thickness (L3) of said permanent magnet (22) ranges between 2 mm and 4 mm and is preferably 3 mm.
